(19) United States
(12) Patent Application Publication
(10) Pub. No.: US 2014/0368357 A1
(43) Pub. Date: Dec. 18, 2014

(54) Carter Concepts - Police Vehicle Safety Arrows

(71) Applicant: Pamela Alethia Carter, Atlanta, GA (US)

(72) Inventor: Pamela Alethia Carter, Atlanta, GA (US)

(21) Appl. No.: 13/917,736

(22) Filed: Jun. 14, 2013

(51) Int. Cl. B60Q 7/00

(52) U.S. Cl. CPC B60Q 7/00
USPC 340/907

(57) ABSTRACT

Carter Concepts—Police Vehicle Safety Arrows are an electrically lit, sequentially moving arrow signaling device for the interior back rear window of a police vehicle. This safety device will be used when police vehicles are parked along the roadside. The arrow signaling device reminds drivers to move over, assisting in police officer safety while on the highways.

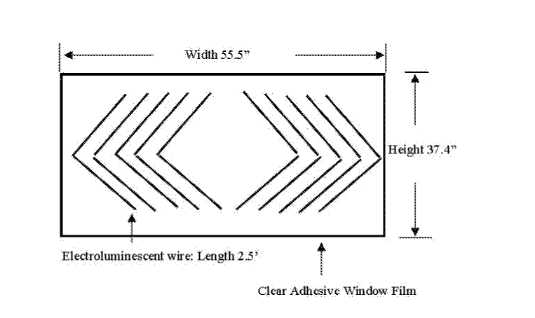

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Carter Concepts—Police Vehicle Safety Arrows are lighting for vehicle illumination and signaling. This product is equipment for safety, protection and warns with directing-type light. This product will aid against danger.

### BRIEF SUMMARY OF THE INVENTION

Carter Concepts—Police Vehicle Safety Arrows are an electronically activated safety device installed to the interior back rear window of a police vehicle. The large electrically lit arrows signal oncoming traffic to move over to the right or to the left of the parked police vehicle on the roadside or highway. The sequential gesturing arrows in this safety device, reminds other vehicles to move over, assisting in the safety of the police officer.

### BRIEF DESCRIPTION OF THE SEVERAL VIEWS OF THE DRAWING

A clear adhesive window film holds electroluminescent wire, which is 2.6 mm in diameter. It has a central copper wire with a phosphorus material coating and two tiny transmitter wires wrapped around it. It is then covered by a PVC coating and finally a vinyl coat.

### DETAILED DESCRIPTION OF THE INVENTION

Carter Concepts—Police Vehicle Safety Arrows are a safety product signaling other vehicles to move over to the left or to the right of a parked police vehicle. Carter Concepts—Police Vehicle Safety Arrows are electroluminescent lit arrows, consisting of thin wires, along the interior back rear window of a police car, moving one at a time in a sequenced pattern. The arrows are secured to window film on the interior rear back window and are not visible until electronically activated by a police officer in a parked police vehicle. This product will assist in the protection of police officers handling issues on the roadways by reminding citizens to move their vehicles over with large gesturing lit arrows.

1. Carter Concepts—Police Vehicle Safety Arrows are electrical, sequentially patterned safety signaling arrows, which are installed along the interior back rear window of a police vehicle.
